(19) United States
(12) Patent Application Publication
(10) Pub. No.: US 2002/0105160 A1
(43) Pub. Date: Aug. 8, 2002

(54) Man-powered vehicle

(76) Inventor: Kuo-Cheng Yen, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/776,775

(22) Filed: Feb. 6, 2001

(51) Int. Cl. B62M 1/00

(52) U.S. Cl. 280/252; 280/251

(57) ABSTRACT

A man-powered vehicle comprises a frame, a front wheel set mounted on the frame, a rear wheel set mounted on the frame, at least one slide board, and a drive mechanism linking the slide board and the rear wheel set such that the rear wheel set is driven to turn at the time when the slide board slides back and forth on the frame.

### FIELD OF THE INVENTION

The present invention relates generally to a vehicle, and more particularly to a man-powered vehicle as a means of transportation and exercise.

### BACKGROUND OF THE INVENTION

Both bicycle and scooter are popular man-powered vehicles. The bicycle is propelled by foot pedals, whereas the scooter is moved by a series of pushes made by one foot against the ground. In terms of exercise effect, the bicycle is inadequate in providing a bicyclist with a well-balanced exercise. In other words, the exercise effect of the bicycle concentrates on two feet of a bicyclist. The exercise effect of the scooter is generally poor in view of the fact that the design of the scooter overemphasizes the body compactness at the expense of exercise effect.

### SUMMARY OF THE INVENTION

The primary objective of the present invention is to provide a manpowered vehicle as a means of transportation and exercise.

The man-powered vehicle of the present invention comprises a frame, a front wheel set pivoted to the frame, a rear wheel set pivoted to the frame, at least one slide board slidably mounted on a slide rail of the frame, and a drive mechanism linked with the slide board and the rear wheel set. As the slide board slides back and forth on the slide rail, the rear wheel set is propelled.

### BRIEF DESCRIPTION OF THE DRAWINGS

FIG. 1 shows a perspective view of a preferred embodiment of the present invention.

FIG. 2 shows an exploded view of the preferred embodiment of the present invention.

FIG. 3 shows a sectional view taken along the direction indicated by a line 3-3 as shown in FIG. 1.

FIGS. 4 and 5 are schematic views of the preferred embodiment of the present invention in action.

### DETAILED DESCRIPTION OF THE INVENTION

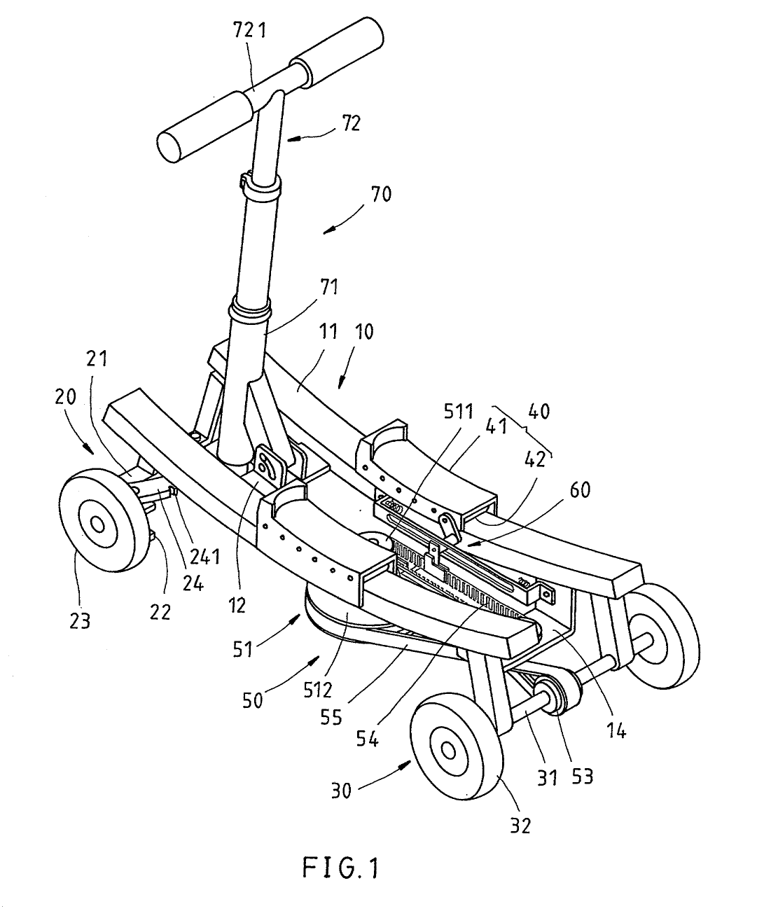

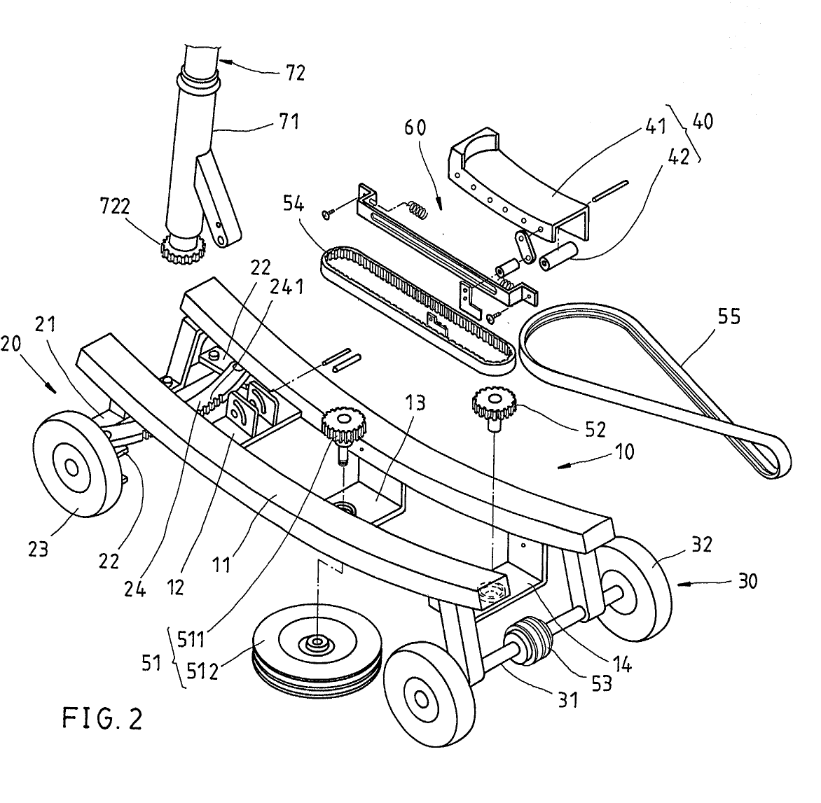

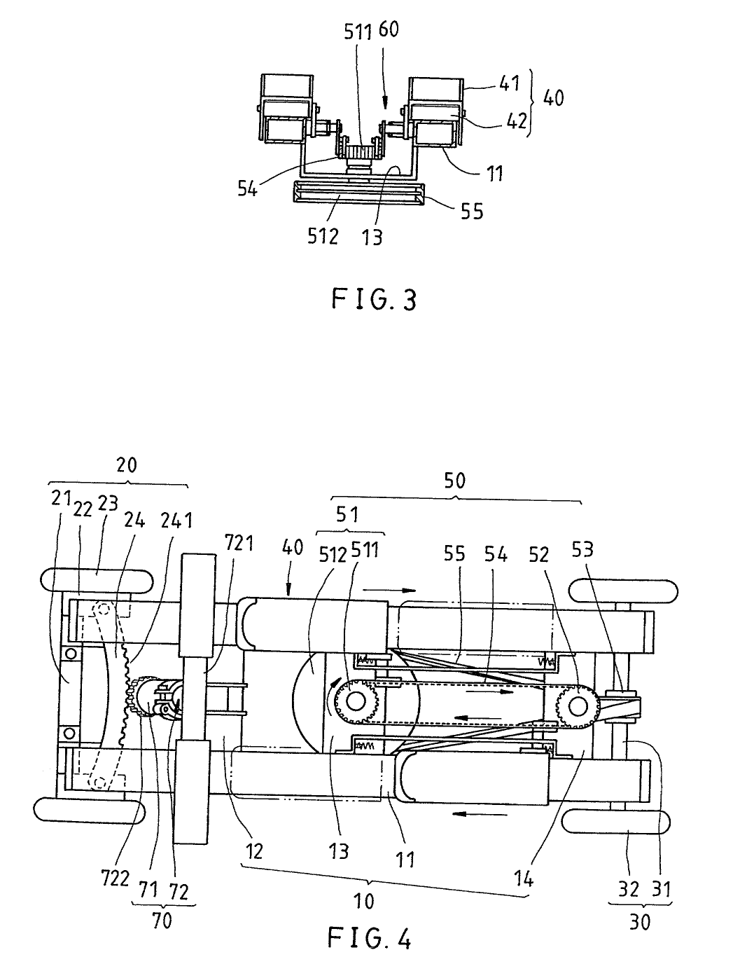

As shown in FIGS. 1-3, a man-powered vehicle 1 embodied in the present invention comprises the component parts which are described hereinafter.

A frame 10 is formed of two curved slide rails 11 parallel to each other, a front connection support 12 disposed between the front ends of the slide rails 11, a middle connection support 13 disposed between the midsegments of the slide rails 11, and a rear connection support 14 disposed between the rear ends of the slide rails 11.

A front wheel set 20 comprises a wheel frame 21, two wheel mounts 22, two wheels 23, and a link member 24. The wheel frame 21 is fastened to the undersides of the front ends of the slide rails 11. The wheel mounts 22 are pivoted with two ends of the wheel frame 21 such that the wheel mounts 22 turn horizontally in relation to the wheel frame 21. The two wheels 23 are pivoted respectively with the wheel mounts 22 such that the wheels 23 are fastened pivotally with two ends of the link member 24. The link member 24 is provided on one side edge with a plurality of racks 241.

A rear wheel set 30 comprises an axle 31 and two rear wheels 32 fastened pivotally with two ends of the axle 31 which is fastened under the rear ends of the slide rails 11.

Two slide boards 40 are formed of a body 41 and a plurality of rollers 42 which are pivoted with the underside of the body 41. The two slide boards 40 are disposed on the two slide rails 11 such that the rollers 42 are slidably located on the slide rails 11. The rollers 42 enable the slide boards 40 to slide back and forth on the slide rails 11.

A drive mechanism 50 comprises a transmission wheel set 51, a second belted wheel 52, a rear transmission belted wheel 53, a first transmission belt 54, and a second transmission belt 55. The transmission wheel set 51 is mounted on the middle connection support 13 and has a first belted wheel 511 located over the middle connection support 13, and a front transmission belted wheel 512 located under the middle connection support 13. The first belted wheel 511 actuates the front transmission belted wheel 512 to turn clockwise. The rear transmission belted wheel 53 is mounted on the axle 31 such that the axle 31 is driven unidirectionally along with the wheels 32 so as to propel the frame 10. The first transmission belt 54 is used to link the first belted wheel 511 and the second belted wheel 52. The second transmission belt 55 is intended to link the front transmission belted wheel 512 and the rear transmission belted wheel 53.

The two slide boards 40 are connected with the first transmission belt 54 by a set of connection member 60. When the slide boards 40 slide on the slide rails 11, the first transmission belt 54 is actuated to run to drive the first belted wheel 511 and the second belted wheel 512. If the first belted wheel 511 turns clockwise, the front transmission belted wheel 512 is actuated to turn, thereby resulting in the rear transmission belted wheel 53 being driven by the second transmission belt 55. As a result, the wheels 32 of the rear wheel set 30 turn to propel the frame 10.

A steering handlebar 70 has a handlebar set 71 which is uprightly mounted on the front connection support 12. A handlebar 72 is rotatably mounted on the handlebar set 71 and is provided with a grip portion 721 and a gear 722 which is meshed with the racks 24 of the link member 24. As the handlebar 72 is turned, the link rod 24 is actuated to drive the two wheels 23.

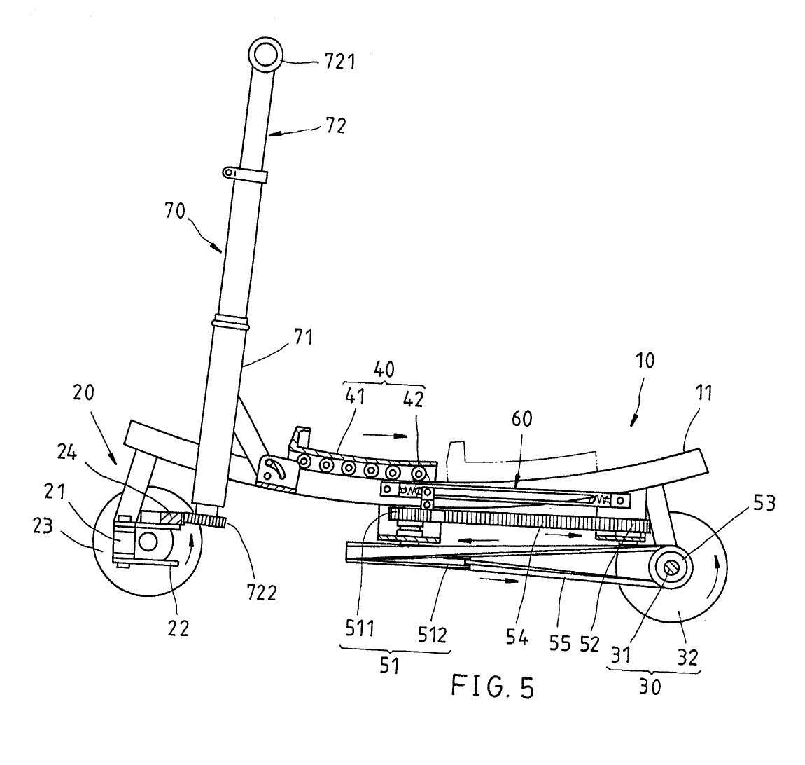

As shown in FIGS. 4 and 5, the man-powered vehicle 1 of the present invention is operated by a person in such a manner that the person stands on the two slide boards 40, and that both hands of the person hold the ends of the grip portion 721. The vehicle 1 is propelled by both feet of the person, which push the slide boards 40 to slide alternately on the slide rails 11, so as to actuate alternately the first transmission belt 54 to run on the first belted wheel 511 and the second belted wheel 53 clockwise and counterclockwise in an alternate fashion. In light of the first belted wheel 511 being capable of driving unidirectionally the front transmission belted wheel 512 to turn clockwise, the front transmission belted wheel 512 is driven by the first belted wheel 511 to turn clockwise. In the meantime, the second transmission belt 55 drives the rear transmission belted wheel 53 to actuate the rear wheel set 30 to move forward.

As the first belted wheel 511 is driven to turn in the counterclockwise direction, the first belted wheel 511 idles in relation to the front transmission belted wheel 512. As a result, when the first transmission belt 54 is driven to run counterclockwise, the front transmission belted wheel 512 is not driven to turn counterclockwise. The vehicle 1 of the present invention is thus propelled forward by the two slide boards 40 which are engaged in a reciprocating motion.

As the handlebar 72 is turned, the link member 24 is driven to displace leftward or rightward by the gear 722 of the bottom end of the handlebar 72. As a result, the wheels 23 are actuated to swivel leftward or rightward.

The man-powered vehicle 1 of the present invention can be used as a means of transportation and exercise. The muscles of legs, hips and waist of a rider of the vehicle 1 are trained at the time when the vehicle 1 is propelled by the rider.

What is claimed is:

1. A man-powered vehicle comprising:
a frame provided with at least one slide rail;
a front wheel set mounted on said frame;
a rear wheel set mounted on said frame;
at least one slide board slidably mounted on said slide rail such that said slide board slides back and forth along said slide rail; and
a drive mechanism mounted on said frame such that said drive mechanism links said slide board and said rear wheel set whereby said rear wheel set is driven to turn at the time when said slide board slides back and forth along said slide rail.

2. The man-powered vehicle as defined in claim 1, wherein said frame is provided with two slide rails parallel to each other whereby said two slide rails are provided with two slide boards slidably mounted thereon.

3. The man-powered vehicle as defined in claim 2, wherein said slide rails are curved.

4. The man-powered vehicle as defined in claim 2, wherein said slide boards are formed of a body and a plurality of rollers, with said rollers being pivoted to an underside of said body whereby said slide boards slide back and forth along said slide rails by said rollers.

5. The man-powered vehicle as defined in claim 1, wherein said front wheel set comprises:
a wheel frame fastened to a front end of said frame;
two wheel mounts pivoted to two ends of said wheel frame such that said wheel mounts turn horizontally in relation to said wheel frame;
two wheels fastened pivotally with said two wheel mounts;
a link member linking said two wheel mounts and having a plurality of racks; and
a steering handlebar having a handlebar seat and a handlebar, said handlebar seat being mounted uprightly on said frame, said handlebar being rotatably mounted on said handlebar seat and being provided at a top thereof with a grip portion and at a bottom thereof with a gear engaging said racks of said link member;
said two wheels being actuated by said link member to turn at the time when said handlebar is rotated.

6. The man-powered vehicle as defined in claim 1, wherein aid rear wheel set comprises an axle fastened pivotally to a rear end of said frame, and two wheels mounted on two ends of said axle.

7. The man-powered vehicle as defined in claim 6, wherein said drive mechanism comprises:
a transmission wheel set mounted in a midsegment of said frame and formed of a first belted wheel, and a front transmission belted wheel whereby said first belted wheel drives unidirectionally said front transmission belted wheel;
a second belted wheel mounted in a rear end of said frame;
a rear transmission belted wheel mounted on said axle whereby said axle is driven unidirectionally by said rear transmission belted wheel;
a first transmission belt running on said first belted wheel and said second belted wheel;
a second transmission belt running on said front transmission belted wheel and said rear transmission belted wheel;
said slide board being connected with said first transmission belt by a connection member such that said first transmission belt is actuated to run at the time when said slide board slides on said slide rail, thereby enabling said first transmission belt to drive said first belted wheel and said second belted wheel whereby said first transmission belt further drives said front transmission belted wheel in the event that said first belted wheel turns in a direction corresponding to a direction in which said front transmission belt is driven to run, thereby enabling said rear transmission belted wheel to be driven by said second transmission belt so as to drive said rear wheel set.
